(19) United States
(12) Patent Application Publication
(10) Pub. No.: US 2014/0297562 A1
(43) Pub. Date: Oct. 2, 2014

(54) SYSTEM AND METHOD FOR ENABLING TRANSFER OF SYSTEMIC RISK EXPOSURE

(71) Applicant: Sciteb Ltd., London (GB)

(72) Inventor: Nicholas Beale, London (GB)

(73) Assignee: Sciteb Ltd., London (GB)

(21) Appl. No.: 14/226,440

(22) Filed: Mar. 26, 2014

Related U.S. Application Data
(60) Provisional application No. 61/805,714, filed on Mar. 27, 2013.

(51) Int. Cl. G06Q 40/06

(52) U.S. Cl. CPC G06Q 40/06
USPC 705/36 R

(57) ABSTRACT

A system and computer-implemented method of facilitating transfer of systemic risk exposure between a plurality of entities having asset portfolios with a sensitivity to one or more of a plurality of common risk factors, the method comprising: for each entity, receiving data representative of the risk appetite of that entity to provide or receive in relation to a counterparty an amount of protection against a given loss in connection with one or more of the said risk factors; and using said data representative of the risk appetites of said entities, matching counterparties to trade systemic risk exposure by way of one or more derivatives contracts for a relevant amount of said protection against a given loss in connection with one or more of the said risk factors.

### CROSS-REFERENCE TO RELATED APPLICATIONS

This application claims priority under 35 U.S.C. 119(e) to U.S. Provisional Patent Application No. 61/805,714, filed Mar. 27, 2013 and entitled “System And Method For Enabling Transfer Of Systemic Risk Exposure.” The entire contents of the above-referenced application is incorporated herein by reference.

### INTRODUCTION

The disclosure includes a system and method by which protection from exposure to systemic risk in a financial system can be offered. In particular, in the system and method disclosed herein, actors in the market seeking protection against systemic risk exposure are enabled to purchase such protection from others in the market who are prepared to offer said protection in return for an expectation of a reasonable profit.

Systemic risk can be defined as the risk of the failure of more than one financial institution in such a way as to damage the proper functioning of the financial system as a whole in some economically significant part of the world. An individual entity or small cluster of entities in a market or financial system may suffer significant losses or even bankruptcy due to the failure of other entities in the market. Recent events have very much made salient to investors and others the problems of systemic risk, and there is a need to provide a mechanism by which protection from exposure to systemic risk in a financial system can be offered.

### BRIEF DESCRIPTION OF THE DRAWINGS

Certain aspects of the disclosure and exemplary embodiments will now be described with reference to the accompanying drawings, in which:

FIG. 1 is a block diagram showing an embodiment of the systemic risk transfer system disclosed herein; and

FIG. 2 is a system diagram illustrating an embodiment of a hardware implementation of the systemic risk transfer system disclosed herein.

### DETAILED DESCRIPTION OF CERTAIN EXEMPLARY EMBODIMENTS

The present applicant has recognised that systemic risks in financial systems are caused in part by the interlinkages or interdependencies between entities in the market. The interdependencies between the entities in the market are complex and may originate from, for example, mutual liabilities between the entities. When one or more entities in a financial system fail due to the interdependencies between the entities throughout the market, there can ensue a cascading loss of confidence in the liquidity of the entities, resulting in more widespread losses and further failures. A discussion of this is set out the present applicant's published paper entitled “Individual versus systemic risk and the Regulator's Dilemma”, Beale et al., Proceedings of the National Academy of Sciences of the United States of America, vol. 108, no. 31, pp 12647-12562, Aug. 2, 2011.

It is known for an entity to protect against financial risks (such as credit risks and market risks) by using suitable derivatives products (such as futures and options). For example, the risk of a substantial decline of the S&P 500 index can be mitigated by buying suitable options. However, the present applicant has recognised that there are significant disadvantages and complexities in trying to use OTC or known exchange-traded derivatives to protect an entity having an investment in a portfolio of assets from systemic risks, for at least the following reasons.
a. Constructing a suitable portfolio of options or other derivatives to protect against a given mix of systemic risk is decidedly complex, and may be infeasible except for the most sophisticated institutional investors.
b. Attendant with this approach, there is a serious issue of counterparty risk that the counterparty to the derivatives contract will not be able to perform their obligations under the derivative. It is all very well for an entity to buy, for example, Credit Default Swaps against the US Government defaulting, but if there were a financial crisis so serious that the US Government defaulted on its debts then there is a risk that the counterparty that sold this CDS protection may also default. Again this counterparty risk exposure is very hard to track for any but the most sophisticated investors.
c. The profit margins for sellers of such derivatives-based “insurance” will often be very high. This would normally attract participants into the market but pretty well the only investors who are able to sell such protection on a large scale are hedge funds who require very large profits to remunerate their staff.
d. Although derivatives have many of the characteristics of insurance and can spread risk to those better able to bear it, they can also spread uncertainty and therefore destabilise the system especially when it is vulnerable. For example, in many cases, the true nature of the risks being transferred by a given derivative transaction may be unclear. Derivatives also provide a transmission mechanism whereby banks and other financial institutions can become more interconnected. As intimated above and in the applicant's referenced paper on this subject, it is a fundamental property of interconnections and interdependencies in financial systems that above a certain strength they induce ambiguity in the state of a financial system and thus risk creating greater instability. It is pretty well impossible for an individual investor to keep track of this interconnectedness and destabilisation. Providing a systemic risk transfer mechanism that actually increases the degree of interconnectedness of entities in a market may actually increase the systemic risks of market instabilities as a whole, thus precluding the realisation of the intended effect of decreasing systemic risk exposure.
e. There is also the fundamental problem of the “Regulator's Dilemma” that measures which improve the security of individual actors in a system do not necessarily improve the resilience of the system as a whole. Thus a mechanism intended to transfer systemic risks in such a way as to only protect individual entities in a market from systemic risks may actually not have any of the desired effects of reducing the risk of failure to which the system as a whole is exposed. Again this is a complex matter which is almost impossible to deal with for individual investors. In addition to these problems, there is another fundamental problem, namely that many investors might be willing to sell some limited amount of systemic protection but are unable to access the investment opportunities involved. For example, Warren Buffett famously made a $5bn investment in Goldman Sachs on highly advantageous terms unavailable to other investors. Buffett invested $5bn in Preferred Shares on 16 Sep. 2008 for which his company received a 10% dividend and warrants to buy $5bn in common stock at a strike price of $115. Although at the time of writing this is higher than the GS stock price, Buffett was repaid his $5bn and received $1.5bn of interest, so the warrants are an upside on a deal that anyway turned out to be very profitable. By contrast, investors who had bought GS ordinary shares on that date would have received dividends but would be sitting on a capital loss of 29%. Warren Buffet was only able to make this investment because his firm has substantial cash reserves and could in extremis have afforded to lose the $5bn investment.

As a result of the above limitations (a-e), there are serious problems with using known derivatives hedging models to effectively protect entities in a financial system from systemic risk. The present applicant has therefore developed the presently disclosed system and method for enabling transfer of systemic risk exposure with the above limitations in mind.

Viewed from one aspect, the present disclosure provides a computer-implemented method of facilitating transfer of systemic risk exposure between a plurality of entities having asset portfolios with a sensitivity to one or more of a plurality of common risk factors, the method comprising: for each entity, receiving data representative of the risk appetite of that entity to provide or receive in relation to a counterparty an amount of protection against a given loss in connection with one or more of the said risk factors; and using said data representative of the risk appetites of said entities, matching counterparties to trade systemic risk exposure by way of one or more derivatives contracts for a relevant amount of said protection against a given loss in connection with one or more of the said risk factors.

In embodiments, the method further comprises receiving data representative of pricing for the protections sought to be offered or desired by the entities. The pricing may be performed using a derivatives model and/or derivatives markets.

In embodiments, matching counterparties comprises, for each potential trade or group of trades of systemic risk exposure between said counterparties, estimating one of more systemic cost functions of the resulting trades representative of their influence on the resilience of the financial system as a whole. Trades may be selectively matched based on the calculation of the systemic cost function or functions. Matching counterparties may further comprise determining, for a plurality of potential combinations of trades a cost function for the resilience of the financial system, and selectively enacting a combination having a cost function that represents a local minimum.

In embodiments, the method further comprises, for each matched pair of counterparties, writing one or more derivatives contracts to transfer the systemic financial risk between said parties. The method may further comprise identifying any unsatisfied risk appetite of said entities and accessing the external derivatives markets to satisfy said risk appetites.

In embodiments, the method further comprises estimating, for one or more of said entities, the sensitivity of their respective portfolios to one or more of said set of common risk factors.

Said estimate of said sensitivity may be used to inform a decision on the risk appetite of each entity. The method may further comprise monitoring the portfolios of said entities and the sensitivities thereof and identifying trades of systemic risk between counterparties that would be mutually advantageous to those counterparties.

Viewed from another aspect, the present disclosure provides a system comprising one or more computing devices comprising one or more non-transitory computer readable media carrying instructions which when executed by said one or more computing devices configures the system to be operable to implement the method of any of the above-described embodiments.

The aim of the above-disclosed system and method is to provide a means by which exposure to systemic risks can be transferred between entities in a financial system. This can also provide a mechanism by which systemic risks can be transferred between entities in a system without increasing the instability of the system as a whole.

The present applicant has recognised that although the world is increasingly globalised there is still less than 100% correlation between the performance of different markets and asset classes. As a result the impact of a given systemic risk is appreciably different in different parts of the global economy. For example the failure of a bank in the Eurozone would have a much greater impact on the economy of Italy than on the economy of Australia. The financial system is preferably the global financial system, the participating entities of which, having portfolios of assets, have exposure to a variety of systemic risks in given markets and asset classes. Systemic risk exposures can therefore be partially separated on a market-wise basis, which may typically also contain a geographic element.

The types of systemic risk against which entities in the financial system require protection will depend on their investment portfolio and their overall financial position. An entity whose main investment is cash on deposit with one particular bank may be pretty well indifferent to most forms of systemic risk but very much in need of protection if that bank fails. Equally an entity who has a significant source of income (say owning a business) may be relatively tolerant of risks that are uncorrelated with the success of his or her business but would need protection against events which caused a sharp reduction in the profits of that business and a reduction in the value of his/her investment portfolio. Diversification and risk transfer within a market does not necessarily have the expected effect of reducing systemic risk. Somewhat ironically, it may have the effect of actually increasing the systemic risk in the market due to an increase in the interdependencies between the market entities.

The system and method of the present disclosure allow entities in a market to buy and sell protection against systemic risk with appropriately matched counterparties preferably in such a way that the risk is transferred with a relatively low systemic cost. The system would preferably be operated by a large professional investment management firm or a network of such firms, although in principle it could be operated by an independent operator or an exchange or a network of exchanges. The most interesting aspect is that this invention works best from a social point of view when there is a very great diversity of risk profiles amongst the providers and buyers of risk protection. Thus ideally the system would be implemented by a relatively large number (say 10) of major Institutional and Retail Investment Managers in a reasonably large number (say 4) of major geographies, the ideally there would be a lot of trade between them.

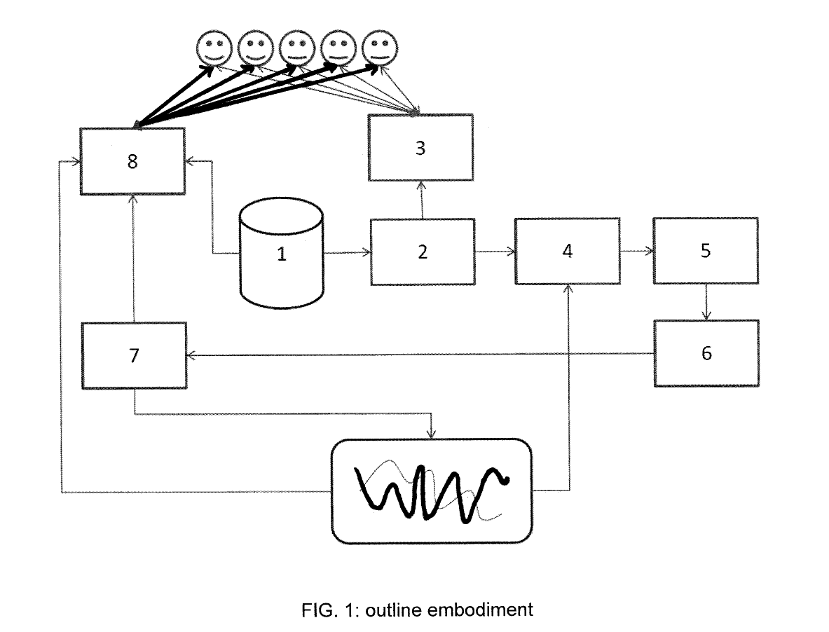

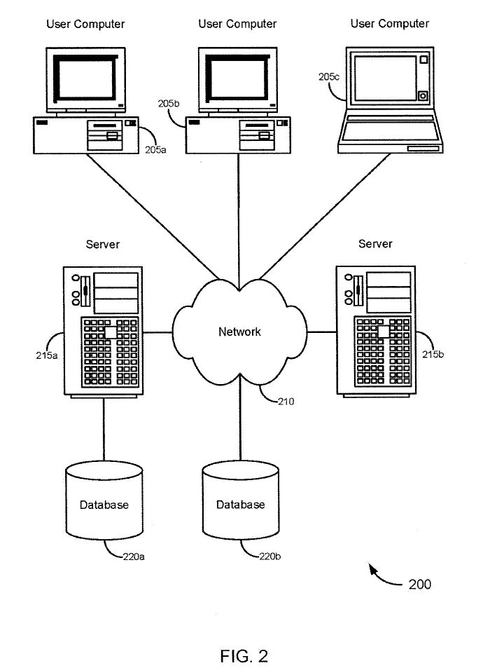

An exemplary embodiment of the system in accordance with the present disclosure is illustrated in FIG. 1. In the system shown in FIG. 1 there are provided a number of functional elements that can be implemented in hardware and/or software using one or more networked computing devices connected to a network such as the internet. The physical layer implementation of the exemplary system of the present disclosure will be described in more detail below, with reference to FIG. 2.

Referring now to FIG. 1, the exemplary embodiment of the system (10) in accordance with the present disclosure comprises the following elements:
Portfolio record storing means (1)
Portfolio sensitivity estimating means (2)
Systemic risk appetite specifying means (3)
Systemic risk protection pricing means (4)
Protection order generation means (5)
Trade match identification and systemic costing means (6)
Trade match solution implementing means (7)
Client entity portfolio monitoring means (8)

The above-identified functional elements of the system of the exemplary embodiment and the operation thereof may comprise one or more computer processors and will now be described in more detail.

### PORTFOLIO RECORD STORING MEANS (1)

In relation to client entities, such as individual or institutional investors, wishing to buy or sell systemic risk protection using the system of the present disclosure, the details of the investment portfolios held thereby are stored using portfolio record storing means (1). The details may be high level, such as the broad asset classes and investment amounts, or more fine-grained including the individual asset details and expected revenue streams.

### PORTFOLIO SENSITIVITY ESTIMATING MEANS (2)

Portfolio sensitivity estimating means (2) may comprise one or more computer processors and is operable to receive a record of an investment portfolio of a client entity from the means for storing records of investment portfolios of one or more client entities (1) and estimate the sensitivity of the value of that portfolio to a common set of risk factors, in order to size the systemic risk exposure. The common set of risk factors are chosen carefully so as to be reflective of the exposure of an investment portfolio of a client entity to different systemic risks. Such risk factors preferably contain some market-wise or geographical dependency and may include, for example regional currency and equity indicators.

In practice, the standard set of risk factors is likely to be complex, including a large number of regions and different asset classes in those regions. For illustrative purposes, however, in the example embodiment, we will consider a highly simplified system in which the common set of risk factors are dependent on just 3 geographical regions (A, B and C) and 3 currencies ($, £, ¥) and the only possible investments are a standard set of equities in each region S_{A}, S_{B} and S_{C}. We will assume that each set of equities is denominated in the currency of the region, and that each client entity does their accounts in one currency. Thus in this simple model each client entity's investments can be considered as a vector of 6 components, namely their equity and cash exposure in each region. For the i^{th} client entity Cᵢ we will denote this exposure Xᵢ and the relevant components as X_{iA}, X_{iB},XiC, X_{i$}, X_{i£, X}_{i¥}respectively. Note that there are effectively only 5 risk factors because the value of currencies is relative. If we write X_{iT} as ΣⱼXᵢⱼ and X_{iA}% as X_{iA}/X_{iT} then in this simple system the sensitivity of a client entity Cᵢ to their home market (assumed to be A for illustrative purposes) is X_{iA}%, the sensitivity to a foreign market is X_{iB}% or X_{iC}% and the sensitivity to a currency movement relative to their home currency is X_{iB}%+X_{i£}% or X_{iC}%+X_{l¥}% as the case may be.

The portfolio sensitivity estimating means (2) may estimate the sensitivity of the value of each client entity's portfolio to the common set of risk factors in any suitable way. The conventional approach to estimating sensitivity of a portfolio to risk factors is of course to use correlations. However, the present applicant recognises that this approach has serious limitations, for the following reasons:
a) Market prices can only reflect information that is understood by a set of participants in the market with sufficient power to influence market prices. Some of the linkages between risk factors and a set of securities may not be sufficiently understood by enough market participants for these linkages to influence prices.
b) The impact of large fluctuations (such as events occurring in the tail of the distribution of possible outcomes) in terms of systemic risk may be very different from the impact of small fluctuations. In many components of the financial and economic system there is an element of “buffering” (whether in terms of capital buffer for a firm or a buffer of stock in a supply chain) before the component fails. These buffers tend to have the effect that small variations in the “input” of the component do not immediately impact the output of the component until the buffer is exhausted or heavily depleted, and generally mean that the relationship between the input and the output is non-linear. Although this can in principle be factored in by the market it often will not be. To give a simplified example of how this non-linearity could be factored in, suppose there is an input X which has no effect on the intrinsic value of company C unless X reaches a threshold (1 say) above which it makes C worthless. Then the market should theoretically price C at approximately (1-p) times its intrinsic value, where p is the probability that X will exceed the threshold.

These considerations mean that an Investment Management firm which has a deeper understanding of the interlinkages between risk factors and tail risk, for example on detailed fundamental analysis of the risks, may be able to offer a more comprehensive assessment of the systemic risk exposure in a portfolio than is achievable by a correlations method.

### SYSTEMIC RISK APPETITE SPECIFYING MEANS (3)

The systemic risk appetite specifying means (3) may comprise one or more computer processors and receives from the portfolio sensitivity estimating means (2) data representative of an estimate of the sensitivity of the value of each client entity's portfolio to a common set of risk factors. The means (2) is then operable to specify the systemic risk appetite of client entities related to the amount of losses the client entities wishes to protect against or offer protection against, based on the common set of risk factors.

Specifying the systemic risk appetite of client entities is a question of understanding what systemic risks Cᵢ is willing to bear (at a sufficiently attractive price) and what systemic risks Cᵢ would wish to obtain protection against (at a suitable price). These may be related to a Threshold Tᵢ below which the client entity would not wish their portfolio to fall.

In reality specifying the systemic risk appetite R, will also be a very complex concept but a methodology in the context of this simplified example is as follows.

For each systemic risk, a number of protections to be offered are defined. In the simplified example, we can assume that all client entity investors have a timeframe of either 1 or 2 years and that they are concerned to protect against losses of either 20% or 40% for each of the common systemic risk factors. There are thus 4 possible protections on offer for each of the 5 common systemic risk factors, with some moderately complex constraints linking these (for example the cost of a 2-year protection against a 40% loss will be at least somewhat related to the cost of two 1-year protections against a 20% loss).

It is possible to also consider protections of combinations of risk factors as well (a client entity with assets distributed between S_{B} and S_{C} might not care if B fell so long as C rose). These complicate the problem without changing the essential nature so for the moment this complication will be neglected, except to note that the number of combinations of risk factors grows very rapidly and therefore the system will work best for complex combinations of risk factors when there are many client entities.

Then, in embodiments, the client entity's risk appetite Rᵢ can be taken as a matrix representation of a quantity and price limit on each of the protection classes j and risk factors r. A positive quantity would represent the amount the client entity would like to be paid if a given risk factor fell by an amount in accordance with a given protection (eg S_{A} fell by 40% in 2 years) provided they could get this “insurance” at a price less than their price limit. A negative quantity would represent the amount the client entity would be prepared to pay if a given risk factor fell by an amount in accordance with a given protection (e.g. S_{B} fell by 20% in 1 year) provided the client entity could be paid at least their price limit for such insurance. The risk appetite R, would typically be a fairly sparse matrix, although one could in principle consider a zero entry as a willingness to see a certain amount of “insurance” at a very high price. This approach neglects the complexity of the point mentioned above about business owners being happier to sustain losses if their income is protected or rising. However, this can be added as a refinement later. It should also be noted that each client entity may wish to set a limit to the total quantity of risk protection that they are willing to sell, summed across all asset classes.

An alternative approach to the risk appetite specification approach set out above may be to build in a “supply curve” and “demand curve” associated with each client entity, but this is an excessive complication for the worked example set out herein.

Some sophisticated client entities may wish to trade their risk protection or hedge it in some way. The system could be extended to accommodate this. To facilitate the ready trading of systemic risk protection in a derivatives aftermarket, it may be preferable to arrange the systemic risk protection by tranches of losses. For the simple example, there could be a 20-40% tranche, and 40-100% tranche. This would mean that each tranche has a clear maximum loss.

A preliminary estimate of a client entity's appetite for buying and selling protections against systemic risks may be inferred from the client entity's portfolio by correlation with the risk appetites of other clients with similar portfolios.

In embodiments, both the exposure portfolio (Xᵢⱼ) and the risk appetite (Rᵢⱼ) can be considered as vectors. To achieve an initial estimation of a risk appetite of a client, if we have a set of known correspondences between Xᵢⱼ and Rᵢⱼ for the clients whose risk appetites we know, then we can look for the portfolio (amongst clients with known risk appetite) which corresponds most closely (pro rata ie scaled to total portfolio) to that of a client with an unknown appetite and then hypothesise a similar risk appetite. A slightly better algorithm might be to take the N closest neighbours and then use a linear interpolation. However, the risk appetite will ultimately have to be confirmed by the client entities themselves. Note that, as discussed below, a key parameter in risk appetite is the non-linearity of risk appetite caused by for example the need to match assets to a certain minimum level of liabilities. It is the non-linearity of risk appetite that makes it rational for inventors to buy protection even if they have the same view as the sellers on the distribution of future outcomes.

### MEANS OF PRICING THE RISK PROTECTION (4)

The systemic risk protection pricing means (4) is then operable to price the protections to be offered for the common system risk factors. This may be achieved, for example, using the derivatives markets for pricing guidance by analysing the price of derivatives contracts offering hedges similar to the protections to be offered in the system against the common set of risk factors. Note that these protections will typically offer considerable economies of scale compared to the work required for constructing the highly complex packages of derivatives required to give the protection. Note also that the derivatives market will be offering a spread so that there will be a price at which the protection is sold and a price at which it is bought, which will not necessarily be the same.

We will suppose for simplicity that the quantities of protection on offer are not sufficient to move the prices. This is more likely to be the case in the light of the discussion below of the protection order generation means (5).

There is a further complexity to be considered in cases where the derivatives markets are not sufficiently deep in the particular contract in question to provide a reliable price for the protection. It may then be desirable to use a model, or a variety of models, to estimate a “fair” price at which a transaction for the protection might be done. Note however that a transaction is only beneficial between parties A and B if the value of what A is selling to B is higher to B than it is to A. Therefore necessarily any “fair” price will be strictly between the value V(A,X) of the protection X to A and the value V(B,X) of the protection to B and there will be a range of fair prices rather than a single price.

In a marketplace, differences between V(A,X) and V(B,X) may in practice be due mainly to a different assessment of the likely evolution of prices of the underlying asset. However even if there is a common view on the future price fluctuations, there may be a difference between V(A,X) and V(B,X) if A and B have different utilities of loss or profit or if one or both of them has a natural hedge so that the overall impact of underlying price fluctuations is different. Consider for simplicity a contract in which A will pay B $1M if a specific condition C occurs (say the price of Oil exceeds $100/barrel) on a specific date D. Let p be the probability of that event and p_{A} and p_{B} be A's and B's estimate of p. Let the value of $1M at D given C (discounted to the present) to A and to B be V_{DCA} and V_{DCB} respectively. Then there will be the possibility of a trade if p_{A}V_{DCA}<p_{B}V_{DCB} and a fair price will lie in the interval (p_{A}V_{DCA} p_{B}V_{DCB}). If they are both using the same model p_{A}=p_{B} so there will be a trade if V_{DCA}<V_{DCB}. As indicated above, if one investor has a non-linear loss function this also creates the possibility of a rational trade. This could be the case if for example A had a completely linear utility of money but B is trying to maximise a Sharpe Ratio then it will have a different utility, especially if B has a portfolio which includes other elements whose value is inversely correlated with condition C.

### PROTECTION ORDER GENERATION MEANS (5)

Once the systemic risk protection pricing means (4) has generated data representative of pricing for the protections to be offered by the system, the protection order generation means (5) may comprise one or more computer processors and is operable to take this pricing data and generate, for a given client entity, an order for the protections based on the risk appetite Rⱼ.

The process of clearing the transactions of the protection internally within the system begins by generating for each client entity an order. This is achieved by setting a price pᵣⱼ for each risk factor r and protection class j and then determining, from the stated risk appetite Rᵢ for that client, the quantity of protection that that client entity wishes to buy or sell at this price. In practice there will be a slight adjustment due to the spread between the “bid” and “offer” prices on offer in the market, but this is a minor detail.

The internal supply/demand capacity in the protection trading system may be asymmetric so as to leave some demand for protection unsatisfied.

The unsatisfied demand can be met by external sources, for example, using the derivatives markets. To determine the amount of protection that is needed by a client entity from external protection, protection order generation means (5) includes means of blending this external protection with protection available to the client entity “internally”. This would be done (subject to 6 and 7 below) in such a way that the benefits of the buy/sell spread were shared between the internal buying and selling client entities pro-rata to the amount of protection that was available “internally” at that price. Note that the price is set by the derivatives markets but the quantity of protection that needs bought externally to satisfy the risk appetite Rᵢ is then only the net position after the internal capacity available at that price is used.

Alternatively, there is also the possibility of adjusting orders to enable bridging trades if there is an excess of demand for one type of protection and an excess of supply of a related type. For example if client entities on aggregate have an unsatisfied demand for 100 units of 1-year protection against a 20% fall in S_{A} and other clients have on aggregate an unsatisfied supply of 50 units of 1-year protection against a 40% fall in SA then it may be better value to enhance each of the 50 40% units with a derivative that pays if there is a 20-40% fall.

It is also worth remarking that although in principle it might be thought that this strategy of placing orders to purchase protections based on common risk factors limits the flexibility of the client entities when compared with their ability to play the derivatives markets and optimise exactly for the protections of their choice, in fact the benefits of standardising the protections, the economies and scale and the ability to “cut out the middleman” are likely to greatly outweigh the theoretical benefits of market timing which can only be achieved by employing super-competent and completely responsible derivatives traders: such people are extremely rare and very expensive (especially when they turn out not to be as competent as had been hoped).

### TRADE MATCH IDENTIFICATION AND SYSTEMIC COSTING MEANS (6)

Once the protection order generation means (5) has generated orders for client entities for the purchase or sale of the protections j of the common systemic risk factors r at a price determined by the Systemic risk protection pricing means (4), the trade match identification and systemic costing means (6) may comprise one or more computer processors and is operable to estimate the implications of the various possible matched trades on the overall resilience and complexity of the financial system as a whole, and of the system of inter-connected clients within the domain of the system.

The problem with entities using the kinds of protection products traded under the current system is that the client entities would only wish to cash them when the system is already in a state of financial stress. Under such conditions relationships that appeared solid can be fragile. In particular protection sold between participants in the system can create a network of mutual interdependencies which may be dangerous, and can move the system closer towards a “monoculture” when all participants are exposed to the same set of risks in the same way.

This is relatively unimportant if the client entities are not leveraged in any way because un-leveraged entities (such as mutual funds) cannot “fail” in a conventional sense. However when banks or other leveraged entities are involved the situation is different. Under these conditions the precise way in which mutual obligations are connected or distributed can make a great deal of difference to the resilience of the system as a whole. Therefore the trade match identification and systemic costing means (6) will assess the expected systemic cost of the various possible ways of organising these interconnections caused by the trades and will find a solution which has relatively low systemic cost. This may mean that some of the trades that could otherwise be made will not be made, and will mean that the system is discriminating in which trades are made between which counterparties.

The details of this will depend of course on the systemic cost function chosen and the details of the configurations in question. But to see the general principle suppose that client entities 1 and 2 each want to sell 2 units of protection and client entities 3 and 4 each want to buy 2 units of the same protection. Then there are 3 different ways of arranging the transfers. Suppose that there is a systemic cost associated with client entities 1 and 3 failing (but not, for simplicity, with client entities 2 and 4 which are unleveraged and cannot “fail”). Then it will generally be better to connect C3 with C2 and C4 with C1 than to connect C3 to C1 since if C1 fails then C3's protection may be less valuable and therefore C3 will be more likely to fail. Of course the real situation will be more complex than this: we can for example think of each client entity as having a weight Wᵢ and the systemic cost being some function of the weights of the client entities that have failed—in general this will be super-linear so for example (ΣᵢWᵢ fᵢ)^{s} where fᵢ is a vector of whether client i has failed and s is a non-linearity factor which will generally be >1: a more sophisticated example would be to have each weight being a vector and the cost function Σⱼ (ΣᵢWᵢⱼfᵢⱼ)̂sᵢ.

The point is that whatever the cost function may be, the system can, given reasonable data and assumptions, estimate a systemic cost associated with each possible configuration of protection exchange and implement the set of protection exchanges that give something close to a minimal cost. It may be computationally infeasible to find the exact global minimum, but by using various forms of non-linear optimisation a sensible approximation can be made.

This optimisation will also consider the identities of the possible counterparties to the derivatives contracts that are not in the system as client entities. For example if client entity Cj is heavily exposed to Bank B then it may be better to use other banks as the counterparties to derivatives that protect Cj in the event of systemic failure. Naturally the information held about client entity exposures and inter-bank exposures will be partial, so the system cannot be expected to be omniscient. However even a very partial model of the external world is likely to lead to decisions that are better than ones which take no account at all of the effect of the external world on systemic stability.

### TRADE MATCH SOLUTION IMPLEMENTING MEANS (7)

Trade match solution implementing means (7) may comprise one or more computer processors and transacts and clears the trades identified as the optimised solution having the lowest systemic cost by the trade match identification and systemic costing means (6).

Depending on the jurisdictions of the client entities and the availability of suitable Central Counterparties/Clearing Houses this may be achieved by contracts through the Central Counterparty or by analogous contracts executed between the client entities, with similar collateral requirements.

In some cases these protection trades will be able to be executed automatically and in other cases they will require manual execution, with the system identifying the trade to an appropriate dealer who may be an employee of the Investment Manager or a third party or (if the client entity is a large enough institution or company) an employee of the client entity.

### CLIENT ENTITY PORTFOLIO MONITORING MEANS (8)

As an adjunct to the system, there is provided client entity portfolio monitoring means (8), which may comprise one or more computer processors and is operable to scan the investment portfolios of client entities (whether their assets are under management or just under custody) and alerting them to opportunities either to adjust their investment portfolios to get a more efficient realisation of essentially the same risk profile, or to profit from opportunities to buy or sell protection against systemic risk.

There are a number of aspects to this:
a. It may be possible to construct a portfolio that has a very similar risk profile but at a somewhat lower cost or offering a higher yield. These opportunities should be identified but the client entity may have good reasons (or reasons which seem good at the time) to prefer their present portfolio, since there will almost always be a possible combination of circumstances under which their present portfolio may be preferable to a suggested alternative.
b. Market prices for the Derivatives may have changed in such a way that is it possible to lock in a profit or limit a loss on any protection that has been sold or purchased. Again not every client entity will want to do this, and the system should learn from their preferences, but client entities should be alerted to the opportunities.
c. Entities that are not yet part of the systemic risk protection service but whose portfolios are known (and whose risk preferences may be inferred) can be offered the opportunity to join the service as clients, possibly including an illustrative cost for the kinds of protections that they would wish to receive (or prices for kinds of protection they might wish to sell).
d. One aspect that is potentially very valuable is that within the System there is a lot more information about the demand and supply curves for systemic risk protection than can be obtained simply from the Derivatives market. This should allow a significantly better job to be done of identifying opportunities for supply and demand than we would if we were looking directly at the markets. The system could for example let a client entity know that if they were prepared to adjust their risk appetite slightly then a potentially valuable trade may be available.
e. Some client entities will have “natural hedges” for certain types of risk. For example an Oil Company or a Sovereign Wealth Fund from a major oil or gas producer should logically be less concerned about making a loss on a contract which obliges them to pay out if the oil price is high, because the circumstances in which they have to pay are also circumstances in which they are making a lot of money for other reasons. Conversely they may be abnormally sensitive to any risks that are likely to correlate with a fall in the price of oil and gas because these would impact their core earnings. The System and

Method could consider these natural hedges (and their converse) both in terms of suggesting modifications to the portfolios and in terms of estimating provisional risk appetite using the systemic risk appetite specifying means (3).

Merely by way of example, FIG. 2 illustrates a schematic diagram of a system 200 that can be used in accordance with one set of embodiments. The system 200 can include one or more user computers 205. The user computers 205 can be general purpose personal computers (including, merely by way of example, personal computers and/or laptop computers running any appropriate flavour of Microsoft Corp.'s Windows™ and/or Apple Corp.'s Macintosh™ operating systems) and/or workstation computers running any of a variety of commercially available UNIX™ or UNIX-like operating systems. These user computers 205 can also have any of a variety of applications, including one or more applications configured to perform methods of the invention, as well as one or more office applications, database client and/or server applications, and web browser applications. Alternatively, the user computers 205 can be any other electronic device, such as a thin-client computer, Internet-enabled mobile telephone, and/or personal digital assistant (PDA), capable of communicating via a network (e.g., the network 210 described below) and/or displaying and navigating web pages or other types of electronic documents. Although the exemplary system 200 is shown with three user computers 205, any number of user computers can be supported.

Certain embodiments of the invention operate in a networked environment, which can include a network 210. The network 210 can be any type of network familiar to those skilled in the art that can support data communications using any of a variety of commercially available protocols, including without limitation TCP/IP, SNA, IPX, AppleTalk, and the like. Merely by way of example, the network 210 can be a local area network (“LAN”), including without limitation an Ethernet network, a Token-Ring network and/or the like; a wide-area network (WAN); a virtual network, including without limitation a virtual private network (“VPN”); the Internet; an intranet; an extranet; a public switched telephone network (“PSTN”); an infrared network; a wireless network, including without limitation a network operating under any of the IEEE 802.11 suite of protocols, the Bluetooth™ protocol known in the art, and/or any other wireless protocol; and/or any combination of these and/or other networks.

Embodiments of the invention can include one or more server computers 215. Each of the server computers 215 may be configured with an operating system, including without limitation any of those discussed above, as well as any commercially (or freely) available server operating systems. Each of the servers 215 may also be running one or more applications, which can be configured to provide services to one or more user computers 205 and/or other server computers 215.

Merely by way of example, one of the server computers 215 may be a web server or an application server, which can include one or more applications accessible by a client running on one or more of the user computers 205 and/or other server computers 215. Merely by way of example, the server computers 215 can be one or more general purpose computers capable of executing programs or scripts in response to the user computers 205 and/or other server computers 215, including without limitation web applications (which might, in some cases, be configured to perform methods of the invention). The application servers) can also include database servers, including without limitation those commercially available from Oracle™, Microsoft™, Sybase™, IBM™ and the like, which can process requests from clients (including, depending on the configuration, database clients, API clients, web browsers, etc.) running on a user computer 205 and/or another server computer 215. Data provided by an application server may be formatted as web pages (comprising HTML, Javascript, etc., for example) and/or may be forwarded to a user computer 205 via a web server (as described above, for example). In some cases a web server may be integrated with an application server.

In accordance with further embodiments, one or more server computers 215 can function as a file server and/or can include one or more of the files (e.g., application code, data files, etc.) necessary to implement methods of the invention incorporated by an application running on a user computer 205 and/or another server computer 215. Alternatively, as those skilled in the art will appreciate, a file server can include all necessary files, allowing such an application to be invoked remotely by a user computer 205 and/or server computer 215. It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more database(s) 220. The location of the database(s) 220 is discretionary. Merely by way of example, a database 220a might reside on a storage medium local to (and/or resident in) a server computer 215a (and/or a user computer 205). Alternatively, a database 220b can be remote from any or all of the computers 205, 215, so long as the database can be in communication (e.g., via the network 210) with one or more of these.

The above-described system can be configured by software to implement the systems and methods for enabling transfer of systematic risk exposure as described herein.

While certain exemplary aspects and embodiments have been described herein, many alternatives, modifications, and variations will be apparent to those skilled in the art.

Accordingly, exemplary aspects and embodiments set forth herein are intended to be illustrative, not limiting. Various modifications may be made without departing from the spirit and scope of the disclosure.

1. A computer-implemented method of facilitating transfer of systemic risk exposure between a plurality of entities having asset portfolios with a sensitivity to one or more of a plurality of common risk factors, the method comprising:
for each entity, receiving data representative of the risk appetite of that entity to provide or receive in relation to a counterparty an amount of protection against a given loss in connection with one or more of the said risk factors; and
using said data representative of the risk appetites of said entities, matching counterparties to trade systemic risk exposure by way of one or more derivatives contracts for a relevant amount of said protection against a given loss in connection with one or more of the said risk factors.

2. A method as claimed in claim 1, further comprising receiving data representative of pricing for the protections sought to be offered or desired by the entities.

3. A method as claimed in claim 2, wherein the pricing is performed using a derivatives model and/or derivatives markets.

4. A method as claimed in claim 1, wherein matching counterparties comprises, for each potential trade or group of trades of systemic risk exposure between said counterparties, estimating one or more systemic cost functions of the resulting trades representative of their influence on the resilience of the financial system as a whole.

5. A method as claimed in claim 4, further comprising selectively matching trades based on the calculation of the systemic cost function or functions.

6. A method as claimed in claim 4, further comprising determining, for a plurality of potential combinations of trades a cost function for the resilience of the financial system, and selectively enacting a combination having a cost function that represents a local minimum.

7. A method as claimed in claim 1, further comprising, for each matched pair of counterparties, writing one or more derivatives contracts to transfer the systemic financial risk between said counterparty entities.

8. A method as claimed in claim 7, further comprising identifying any unsatisfied risk appetite of said entities and accessing the external derivatives markets to satisfy said risk appetites.

9. A method as claimed in claim 1, further comprising estimating, for one or more of said entities, the sensitivity of their respective portfolios to one or more of said set of common risk factors.

10. A method as claimed in claim 9, wherein said estimate of said sensitivity is used to inform a decision on the risk appetite of each entity.

11. A method as claimed in claim 9, further comprising monitoring the portfolios of said entities and the sensitivities thereof and identifying trades of systemic risk between counterparties that would be mutually advantageous to those counterparties.

12. A system comprising one or more computing devices comprising:
one or more non-transitory computer readable media carrying instructions which when executed by said one or more computing devices configures the system to be operable to implement the method as claimed in claim 1.
